(19) United States
(12) Patent Application Publication
(10) Pub. No.: US 2004/0233283 A1
(43) Pub. Date: Nov. 25, 2004

(54) Apparatus and method of detecting change in background area in video images

(76) Inventors: Goo-ho Kang, Suwon-city (KR); Heung-soo Kim, Suwon-city (KR); Jae-soo Cho, Yongin-city (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/847,329

(22) Filed: May 18, 2004

(30) Foreign Application Priority Data
May 19, 2003 (KR) 2003-31673

(51) Int. Cl. H04N 7/18

(52) U.S. Cl. 348/143; 340/500; 348/155

(57) ABSTRACT

Disclosed are an apparatus and a method of detecting change in a background area. The apparatus comprises: at least one image pick-up device for picking up an image of an object zone; a background area extraction section for extracting a background area by excluding a moving area from a current input image picked up by the at least one image pick-up device; a reference image storage section for storing a predetermined reference image for the object zone; a comparison section for comparing the background area with the reference image; and a judging section for determining whether there has been change in the background area on the basis of the comparison result of the comparing section and outputting the result. Using the disclosed apparatus and method, it is possible to enhance efficiency of security, and to effectively cope with theft, calamity, or the like, because the apparatus and method can determine an invader's action of intentionally interrupting normal operation of an image pick-up apparatus.

### CROSS-REFERENCE TO RELATED APPLICATIONS

This application claims benefit under 35 U.S.C. §119(a) of Korean Patent Application No. 2003-31673, filed on May 19, 2003, in the Korean Intellectual Property Office, the entire contents of which are incorporated herein by reference.

### BACKGROUND OF THE INVENTION

1. Field of the Invention

The present invention relates to an apparatus and a method of detecting change in a background area of a video image, and in particular, to an apparatus and a method of detecting change in a background area of a video image by way of comparing a background area extracted from a current input image and a reference background image.

2. Description of the Related Art

It is prevalent in today's society to install surveillance cameras in locations where guards and security are required (e.g., a cash dispenser, a vending machine, a factory, a residency, among others) without the immediate presence of security personnel. Such surveillance systems are designed to monitor and prevent theft, fires, or similar events through an image transmitted from the surveillance camera to a control room, where the transmitted image is stored on a hard disk or a tape. Presently available digital video recorders perform data compression of digital image signals and also use image signal processing algorithms, which result in more intelligent surveillance systems.

Although digital video recorders have become more intelligent, there is a problem in that the digital video recorders become useless if the invader intentionally changes the angle of view of the surveillance camera, sprays liquid onto the camera lens, obscures the cameral lens with some material, or cuts the camera cable. A need therefore exists for an apparatus and/or method to overcome this problem.

### SUMMARY OF THE INVENTION

An object of the present invention is to substantially solve at least the above problems and/or disadvantages and to provide at least the advantages described below. Accordingly, it is an object of the present invention to provide an apparatus and method of detecting change in a background area of an object zone in video images.

It is a further object of the present invention to provide a method for detecting change in a background area of an object zone in a video image, the method comprising setting and storing a reference background image R(t) with respect to the object zone to be monitored, capturing periodically a current input image I(t) of the object zone by at least one image pick-up device, and extracting a background area B(t) of the object zone by excluding a moving area M(t) corresponding to one or more moving objects from the current input image I(t) of the object zone transmitted from the image pick-up devices. The method for detecting change in a background area of an object zone in a video image further comprises comparing the background area B(t) with the reference background image R(t) and judging whether the background area B(t) has changed relative to the reference background image R(t) on the basis of a comparison result comparing the background area B(t) and the reference background image R(t).

It is still a further object of the present invention to provide a method for operating an alarming device when a change in a background area of an object zone is detected by an apparatus for detecting change in a background area of a video image, wherein the method comprises operating the alarming device according to the operating parameters to notify the user of a change in the background area B(t) of the object zone, determining whether a user has defined additional parameters for operating the alarming device when a change in the background area of an object zone has been detected and verified by the user, and if so, operating the alarming device in accordance with the additionally defined parameters, and capturing a current input image I(t) of an object zone by at least one image pick-up device and viewing a current output image I(t) of the object zone by at least one image output device as long as the alarming device is operated.

It is another object the present invention to provide an apparatus for detecting change in a background area of an object zone in a video image, wherein the apparatus comprises at least one or more input image pick-up devices for capturing periodically a current input image I(t) of the object zone, a background extraction section for extracting a background area B(t) of the object zone in the video image, and a reference background image storage section for storing a reference background image R(t) of the object zone. The apparatus for detecting change in a background area of an object zone in a video image further comprises a comparison section for comparing the background area B(t) of the object zone output from the background area extraction section versus the reference background image R(t) of an object zone, and a judging section for judging whether the background area B(t) has changed relative to the reference background image R(t) on the basis of a comparison result output from the comparison section.

### BRIEF DESCRIPTION OF THE DRAWINGS

The above and other aspects, features and advantages of the present invention will be more apparent from the following detailed description taken with reference to the accompanying drawings, in which:

FIG. 1 is a block diagram of the apparatus for detecting change in a background area of a video image;

FIG. 2 is a detailed block diagram of the background area extraction section shown in FIG. 1;

FIG. 3 is a detailed block diagram of the mean image calculation section shown in FIG. 2;

FIG. 4 is a block diagram illustrating image signal processing;

FIGS. 5A to 5D are additional block diagrams illustrating image signal processing;

FIGS. 6A to 6D are still further block diagrams illustrating image signal processing;

FIG. 7 is a flowchart illustrating a method for detecting change in a background area of a video image; and

FIG. 8 is a flowchart illustrating a method for operating an alarming device with user's settings when the alarming device has been operated.

### DETAILED DESCRIPTION OF THE PREFERRED EMBODIMENTS

Various embodiments of the present invention will now be described in detail with reference to the accompanying drawings.

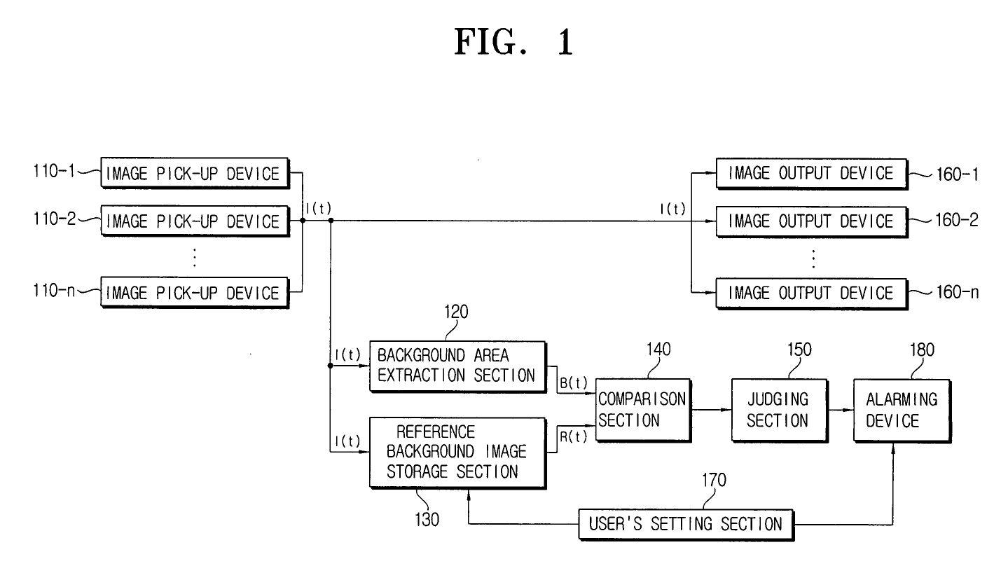

FIG. 1 is a block diagram of the apparatus for detecting change in a background area of a video image (hereinafter, to be also referred to as “change-in-background detecting apparatus”). The change-in-background detecting apparatus comprises at least one image pick-up device 110-1˜110-n, a background area extraction section 120, a reference background image storage section 130, a comparison section 140, a judging section 140, at least one image output device 160-1˜160-n, a user's setting section 170, and an alarming device 180.

The image pick-up devices 110-1˜110-n transmit a current input image I(t) obtained from an object zone to the background area extraction section 120, the reference background image storage section 130, and a plurality of image output devices 160-1˜160-n. Herein, the term “current input image I(t)” indicates an image obtained by one of image pick-up devices 110-1˜110-n The change-in-background detecting apparatus can be provided with a plurality of image pick-up devices 110-1˜110-n in order to make it possible either to monitor one object zone at various angles, or to concurrently monitor a plurality of object zones.

The background area extraction section 120 extracts a background area B(t) of an object zone by excluding a moving area M(t) corresponding to one or more moving objects from the current input image I(t) transmitted from the image pick-up devices 110-1˜110-n, and transmits the background area B(t) to the comparison section 140. Herein, the term “background area B(t)” indicates an image obtained by excluding a moving area M(t), which indicates an image of one or more moving objects, from the current input image I(t).

The reference background image storage section 130 is a medium for storing a reference background image R(t) of an object zone, wherein the reference background image storage section 130 transmits the reference background image R(t) stored therein to the comparison section 140. Herein, the term “reference background image R(t)” indicates a still image of an object zone free of any moving object and is formed from the background of the object zone only. With the change-in-background apparatus, a reference background image R(t) is capable of being set by a user and stored. The reference background image R(t) set by a user is maintained until the user re-sets the reference background image R(t), and is not changed in real time, which is different from the current input image I(t).

The comparison section 140 serves to compare a background area B(t) received from the background area extraction section 120 with a reference background image R(t) received from the reference background image storage section 130, and transmits the result of the comparison to the judging section 150. In particular, the comparison section 140 calculates the absolute values C(i, j, t) of difference between the pixel value R(i, j, t) of the reference background image and the pixel value B(i, j, t) of the background area, and transmits the absolute values to the judging section 150.

The judging section 150 serves to determine whether the background area B(t) has been changed relative to the reference background image R(t) on the basis of the comparison result received from the comparison section 140, and transmits the result of the determination to the alarming device 180.

The image output devices 160-1˜160-n serve to reproduce the current input image I(t) received from the at least one image pick-up device 110-1˜110-n. Two or more image output devices 160-1˜160-n can be provided to reproduce the current input image I(t) picked up by two or more image pick-up devices 110-1˜110-n corresponding thereto, respectively. Further, when an action interrupting the normal operation of image pick-up devices 110-1˜110-n is detected, the image output devices 160-1˜160-n can perform an alarming function for informing a user of the situation by displaying it.

When receiving information that the background area B(t) has been changed from the judging section 150, the alarming device 180 informs the user of the situation using a speaker, a buzzer, a display device or the like. In addition, if the user confirms that an invader has disturbed the current input image I(t) through at least one image output device 160-1˜160-n, the user can demand an additional operation of the alarming device 180 through the user's setting section 170. The alarming device 180 can perform additional operations of operating a siren installed within the object zone, closing an entrance, or notifying a security agency of the situation.

The user is allowed to set a reference background image R(t) for the object zone to be imaged through the user's setting section 170. When it is determined that the background area B(t) of the current input image I(t) has been changed from the reference background image R(t), the user is also allowed to set whether to operate the alarming device 180 or not. In addition, if the alarming device 180 has been operated, the user is allowed to determine whether an invader intentionally interrupted the normal operation of an image pick-up device 110-1˜110-n, or an alarm was generated by the image pick-up devices 110-1˜110-n in error. Such errors, also referred to as “false positives”, can be caused by contact of foreign matter in the air, an insect or the like with the lens of the image pick-up device 110-1˜110-n. When it is determined that an invader has interrupted the operation of the image pick-up device, the user is allowed to set, through the user's setting section 170, the alarming device 180 to perform additional operations of operating a siren installed within the object zone, closing an entrance, or notifying a security agency of the situation

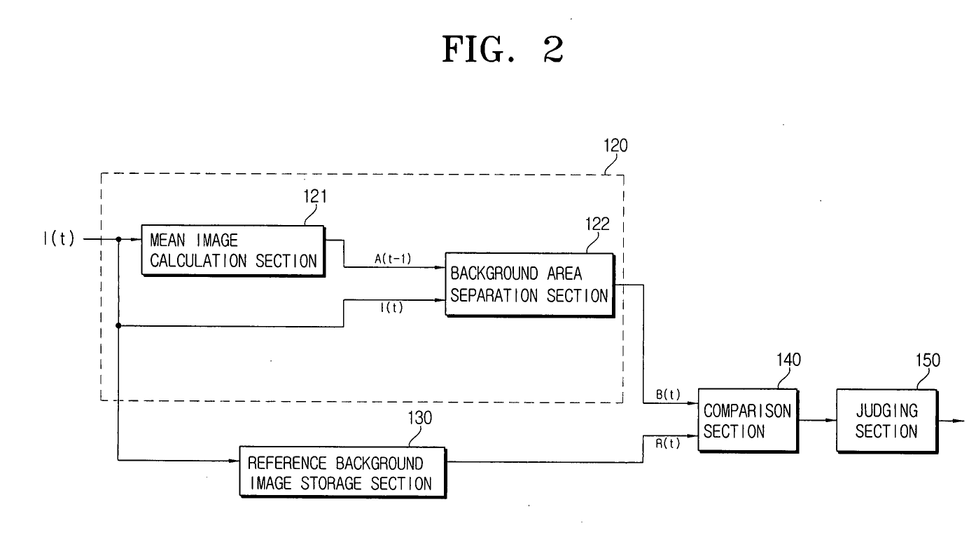

FIG. 2 is a detailed block diagram of the background area extraction section 120 of FIG. 1. In order to aid in comprehension of the embodiments of the present invention, the reference background image storage section 130, the comparison section 140 and the judging section 150 are also shown in FIG. 2 and the part surrounded by dotted lines corresponds to the background area extraction section 120. The background extraction section 120 consists of a mean image calculation section 121 and a background area separation section 122.

The mean image calculation section 121 calculates a previous mean image A(t−1) up to the latest input image I(t−1) prior to the current input image I(t), and transmits the previous mean image A(t−1) to the background area separation section 122.

The background area separation section 122 compares the pixel value I(i, j, t) of the current input image I(t) with the pixel value A(i, j, t−1) of the previous mean image A(t−1), extracts an area determined as the background area B(t), and transmits the background area B(t) to the comparison section 140.

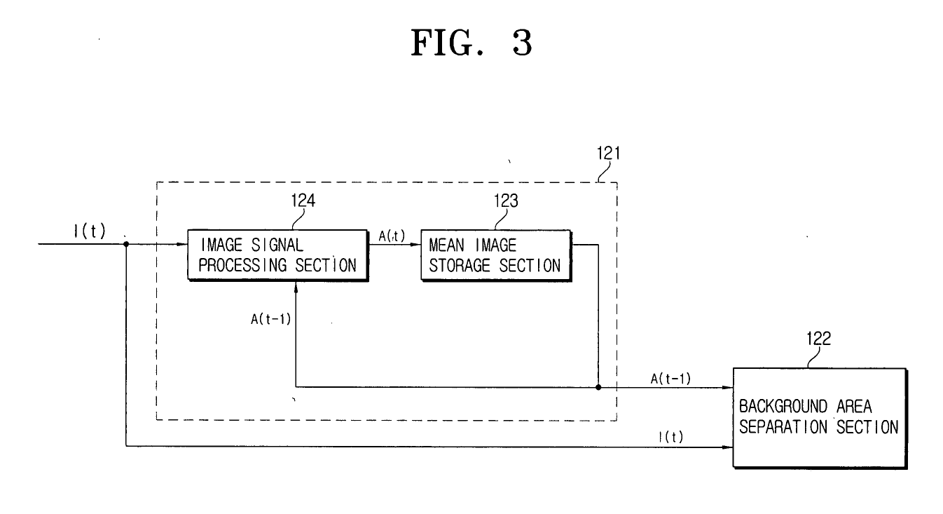

FIG. 3 is a detailed block diagram of the mean image calculation section 121. In the drawing, the part indicated by dotted lines is the mean image calculation section 121 and, to aid in understanding the various embodiments of the present invention, the background area separation section 122 is also shown in the drawing. The mean image calculation section 121 includes a mean image storage section 123 and an image signal processing section 124.

The mean image storage section 123 transmits the stored previous mean image A(t−1) to the image signal processing section 124 and the background area separation section 122.

The image signal processing section 124 calculates a current mean image A(t) based on the current input image I(t) and the previous mean image A(t−1) received from the mean image storage section 123, and transmits the current mean image A(t) to the mean image storage section 123. Then, the current mean image A(t) is stored in the mean image storage unit 123.

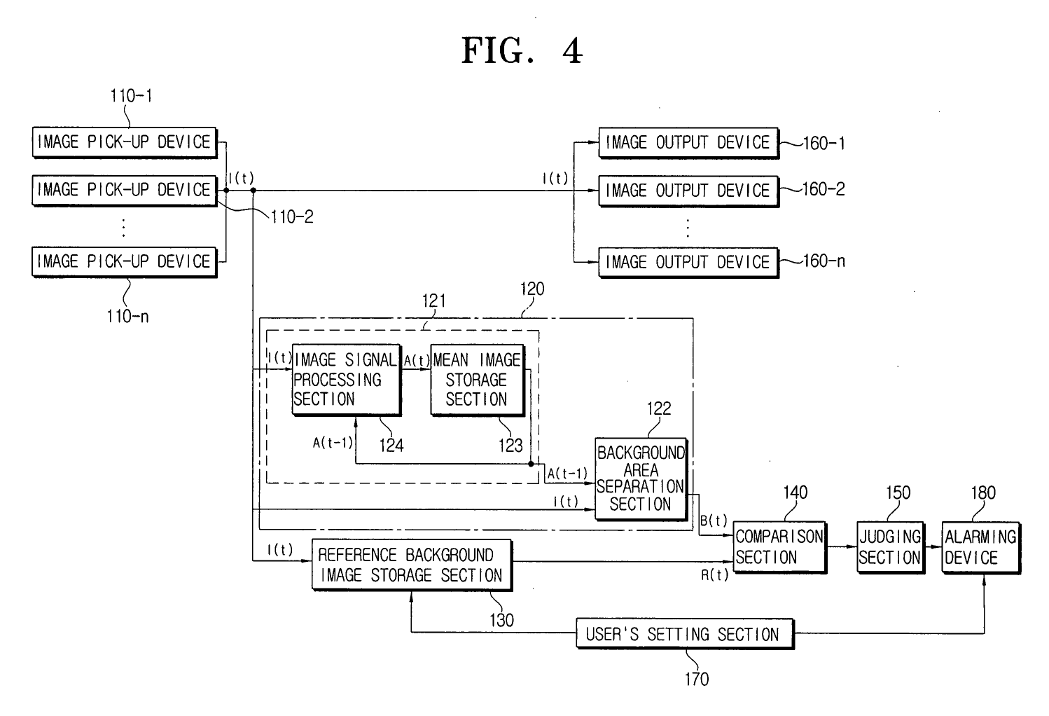

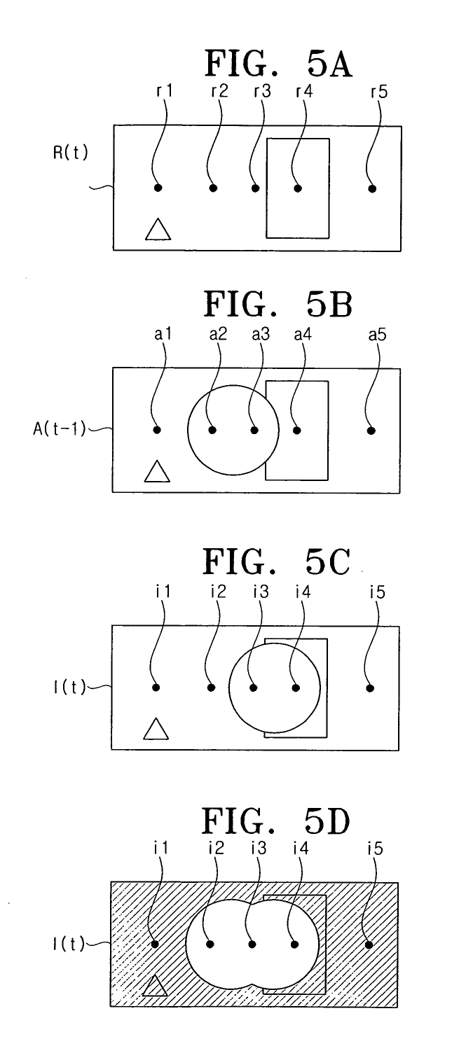

FIGS. 4 to 6 are views illustrating image signal processing used in the various embodiments of the invention. FIG. 4 illustrates the paths through which image signals are transmitted in the change-in-background detecting apparatus, and FIGS. 5A to 5D illustrate examples of the reference background image R(t), the previous mean image A(t−1), the current input image I(t), and the background area B(t).

Referring to FIG. 4, the current input image I(t) is received by one of the plurality of image pick-up devices 110-1˜110-n, and transmitted to the image output devices 160-1˜160-n corresponding to the image pick-up devices 110-1˜110-n, the image signal processing section 124, the background area separation section 122, and the reference background image storage section 130. The current input image I(t) transmitted to the image output devices 160-1˜160-n corresponding to the image pick-up devices 110-1˜110-n is reproduced through the image output devices 160-1˜160-n, so that a user is allowed to monitor the current input image I(t).

The reference background image storage section 130 sets as a reference background image R(t), the current input image I(t) which is received during an initial operation of the change-in-background detecting apparatus and which has no moving objects in the object zone, and stores the set reference background image R(t).

FIG. 5A shows one example of the reference background image R(t), in which the figures of a triangle and square are some parts of the background of the object zone. For example, if it is defined that the object zone is a place where an unmanned cash dispenser is installed, the square denotes the cash dispenser and the triangle denotes an air conditioner or a paper shredder installed in that location. Therefore, the reference background image R(t) is free from any moving object images.

Referring back to FIG. 4, the image signal processing section 124 calculates the current mean image A(t) based on the current input image I(t) and the previous mean image A(t−1). The previous mean image A(t−1) indicates a mean image up to and including the previous input image I(t−1), and the current mean image A(t) indicates a mean image up to and including the current input image I(t). The current mean image A(t) is calculated by multiplying the previous mean image A(t−1) and the current input image I(t) by different weight values, respectively, and then summing the multiplied results. This can be expressed as following equation:

A(i, j, t)=(1−w)I(i, j, t)+wA(i, j, t−1)

A(i, j, t) is a pixel value of a current mean image up to the current input image for the jth pixel in the ith line, I(i, j, t) is a pixel value of the current input image for the jth pixel in the ith line, A(i, j, t−1) is a pixel value of a previous mean image up to the latest image for the jth pixel in the ith line, and w is a predetermined historical weight. The historical weight, w, is set in the range of from 0 to 1, and the change of current mean image A(t) becomes insignificant as the historical weight approaches 1. The pixel value A(i, j, t) of current mean image is updated in the following manner: A(i, j, t)=(1−w)I(i, j, t)+wA(i, j, t−1). A(i, j, t) is produced by multiplying the pixel value of the current input image, I(i, j, t), by (1−w), and multiplying the pixel value A(i, j, t−1) of the previous mean image by w, and then summing the multiplied results. The result is a pixel value of the mean image, and A(i, j, t) is stored in the mean image storage section 123, so that the pixel value of the mean image will be updated from A(i, j, t−1) to A(i, j, t).

The background area separation section 122 calculates the background area B(t) based on the current input image I(t) and the previous mean image A(t−1). The background area separation section 122 calculates the absolute value of difference between the pixel value I(i, j, t) of the current input image and the pixel value A(i, j, t−1) of the previous mean image. If the absolute value is greater than or equal to a first preset threshold T1, the background area separation section 122 determines the pixel to be that of a moving area M(t), while if the absolute value is less than the first preset threshold T1, the background area separation section 122 determines the pixel to be that of the background area B(t). Therefore,

if |I(I, j, t)−A(I, j, t−1)|>=T1, then B(t) is set to M(t); else

if |I(I, j, t)−A(I, j, t−1)|<T1, then B(t) remains as B(t).

The first threshold T1 is a value used in determining whether respective pixels have changed or not, on the basis of the magnitudes of absolute values of difference between the pixel value I(i, j, t) of the current input image and the pixel value A(i, j, t−1) of the previous mean image.

FIG. 5B shows one example of the previous mean image A(t−1), and FIG. 5C shows one example of the current input image I(t). The circle shown in the drawings indicates a moving area M(t), which is an image of a moving object (e.g., a customer using the cash dispenser). If it is assumed that the object is moving to the right side, the moving area M(t) of the current input image I(t) is closer to the right side in FIG. 5C than the moving area M(t−1) of the previous mean image A(t−1) in FIG. 5B.

In FIGS. 5B to 5C, the elements a1 to a5 indicate pixels of the previous mean image A(t−1), and the elements i1 to i5 indicate pixels of the current input image I(t) corresponding to the positions of a1 to a5. The pixel value of a1 is identical to that of i1 and the pixel value of a5 is also identical to that of i5. The absolute value of difference between the corresponding pixels is ‘0’. If it is defined that the pixel values of a2, a3, and a4 are 20, 40, 65, respectively, and if it is defined that the pixel values of i2, i3, i4 are 5, 20, 40, respectively, then the absolute values of differences between the corresponding pixel values are 15, 20, 25, respectively. Thus, if T1 is ‘11’, i2, i3, i4 are determined to be a moving area M(t) because the absolute values of difference between the corresponding pixel values are equal to or greater than T1 (11). Further, i1, i5 are determined to be a background area B(t) because the absolute values of difference between the pixel values are less than T1 (11). The background area B(t) is expressed by oblique lines as shown in FIG. 5D.

Referring back again to FIG. 4, the comparison section 140 calculates the absolute value of the difference between the pixel value R(i, j, t) of the reference background image and the pixel value B(i, j, t) of the background area B(t), and transmits the calculated value to the judging section 150. If the number of pixels, of which the absolute values received from the comparison section 140 is less than a second preset threshold T2, are also less than a third preset threshold T3, the judging section 150 determines that the background area B(t) has been changed because it is very different from the reference background image R(t), and outputs the result. If the number of pixels is equal to or greater than the third preset threshold T3, the judging section 150 determines that the background area B(t) has not been changed because it is not so different from the reference background image R(t) and outputs the result. The “second threshold” T2 is a value to be referenced when determining whether pixel values of a background area B(i, j, t) have been changed or not, on the basis of the magnitudes of absolute values of the difference between the pixel values of a background area and a reference image. The “third threshold” T3 is a value to be referenced when determining whether the background area B(t) has been changed from the background reference image R(t) on the basis of the number of the changed pixels.

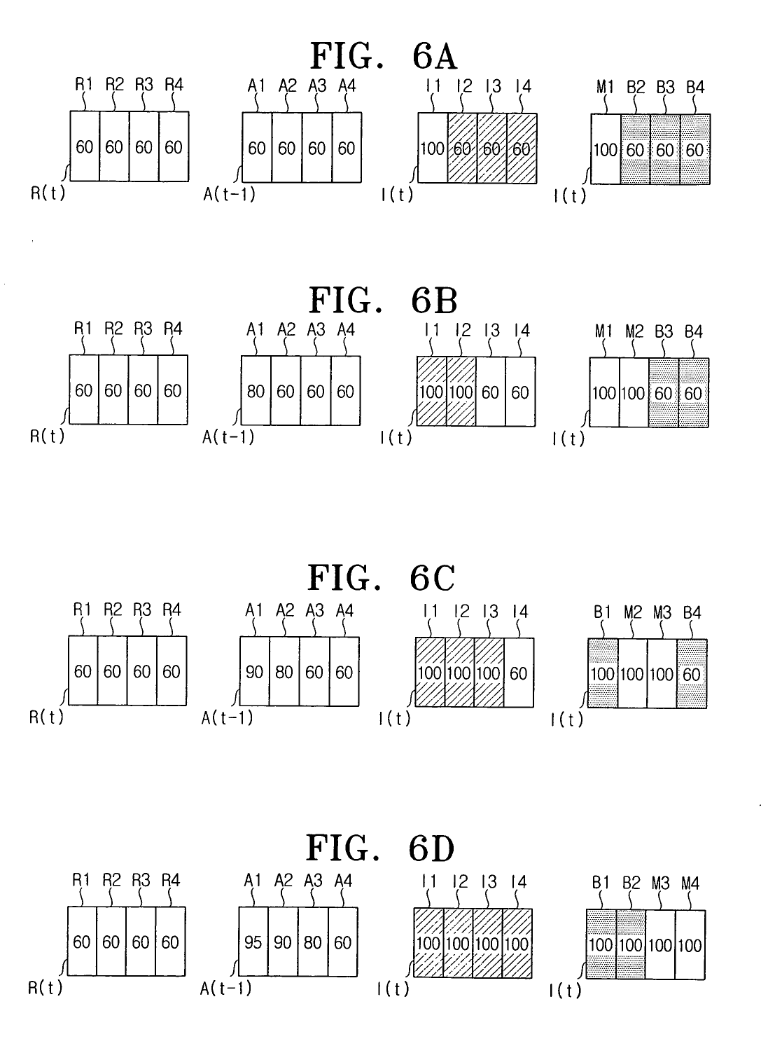

FIGS. 6A to 6D are additional views to assist in explaining the process for detecting change in a background area. FIGS. 6A to 6D illustrate the images of R(t), A (t−1), I(t) appearing when the object moves to the right side as the time lapses, obscuring the image pickup device, in which each image is divided into 4 areas for the convenience of explanation. It is assumed that one area is comprised of 200,000 pixels and thus one image is comprised of 800,000 pixels. The numerals of the drawings indicate the pixel value of each area. In this illustration, to aid in understanding, it is assumed that the background of the object zone has a pixel value 60, and the moving object of the image I(t) has a pixel value 100. It is also assumed that T1 and T2 are both “11”, T3 is one hundred thousand (100,000), and the a historical weight “w” is “0.5”.

FIG. 6A shows a state where the image pick-up device is obscured as much as ¼ by the moving object. In FIG. 6A, since the absolute value of I1-A1 is 40, which is equal to or greater than T1 (11), I1 is determined to be a moving area M1. Since the absolute values of I2-A2, I3-A3, and I4-A4 are 0, which are less than T1 (11), I2, I3, I4 are determined to be background areas B2, B3, B4. Furthermore, since the absolute values of B2-R2, B3-R3, B4-R4 are also 0, the number of pixels in which the absolute values are less than T2 (11), is 600,000 (200,000 pixel*3), which is equal to or greater than T3 (100,000). Accordingly, it is determined that the background area has not been changed.

FIG. 6B shows a state where the image pick-up device is obscured as much as ½ by the moving object. In FIG. 6B, since Al has a pixel value 80 by the calculation of (60*0.5+100*0.5), the absolute value of I1-Al is 20 and the absolute value of I2-A2 is 40, both of which are equal to or greater than T1 (11), and I1 and I2 are determined to be moving areas M1 and M2. Also, since the absolute values of I3-A3 and I4-A4 are 0, which is less than T1 (11), I3 and I4 are determined to be background areas B3 and B4. Since the absolute values of B3-R3 and B4-R4 are 0, the number of pixels, of which the absolute values are less than T2 (11), is 400,000 (200,000 pixel*2), which is equal to or greater than T3 (100,000). Accordingly, it is determined that the background area has not been changed.

FIG. 6C shows a state where the image pick-up device is obscured as much as ¾ by the moving object. In FIG. 6C, since A1 has a pixel value 90, as determined by the calculation of (80*0.5+100*0.5) and A2 has a pixel value 80 by the calculation of (60*0.5+100*0.5), the absolute value of I2-A2 is 20 and the absolute value of I3-A3 is 40, both of which are equal to or greater than T1 (11). Accordingly, I2 and I3 are determined to be moving areas M2 and M3. Also, since the absolute value of I1-A1 is 10 and the absolute value of I4-A4 is 0, both of which are less than T1 (11), I1 and I4 are determined to be background areas B1 and B4. Since the absolute value of B1-R1 is 40 and the absolute value of B4-R4 is 0, the number of pixels, of which the absolute value is less than T2 (11), is 200,000 (200,000 pixel*1), which is equal to or greater than T3 (100,000). Accordingly, it is determined that the background area has not been changed.

FIG. 6D shows a state where the image pick-up device is completely obscured by the moving object. In FIG. 6D, since A1 has a pixel value 95 by the calculation of (90*0.5+100*0.5), A2 has a pixel value 90 by the calculation of (80*0.5+100*0.5), and A3 has a pixel value 80 by the calculation of (60*0.5+100*0.5), the absolute value of I3-A3 is 20 and the absolute value of I4-A4 is 40, both of which are equal to or greater than T1 (11). Accordingly, I3 and I4 are determined to be moving areas M3 and M4. Also, since the absolute value of I1-A1 is 5 and the absolute value of I2-A2 is 10, both of which are less than T1 (11), I1 and I2 are determined to be background areas B1 and B2. Since the absolute values of B1-R1 and B2-R2 are 40, the number of pixels, of which the absolute values are less than T2 (11), is 0 (200,000 pixel*0), which is less than T3 (100,000). Accordingly, it is determined that the background area has been changed.

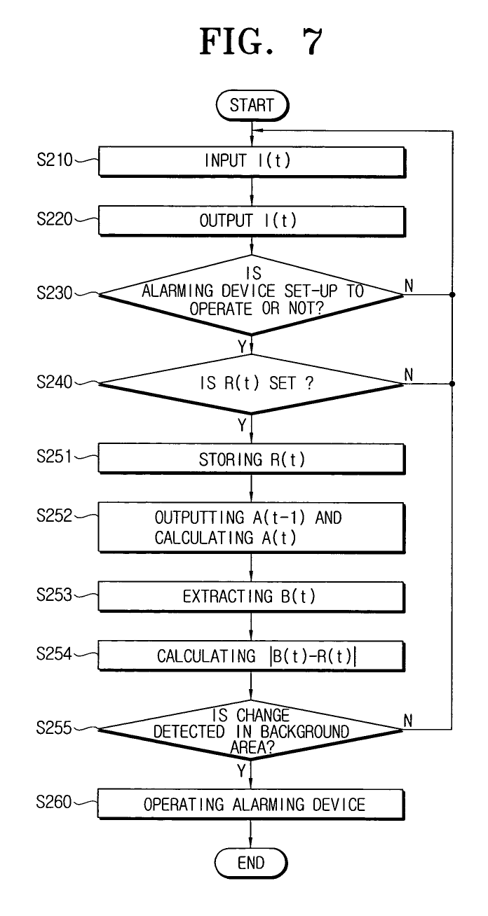

FIG. 7 is a flow chart illustrating the method for detecting change in a background area. A current input image I(t) periodically captured by the image pick-up devices 110-1˜110-n is input to the change in background detection apparatus (step S210). The input current input image I(t) is reproduced by the image output devices 160-1˜160-n, thereby allowing a user to monitor the situation of the object zone (step S220).

The user can input, through the user's setting section 170, parameters to determine whether to operate an alarming device 180 informing the user of the situation or not if an invader interrupts the normal operation of the at least one image pick-up device 110-1˜110-n (decision step S230). The alarming device 180 serves to notify the situation of the object zone to the user. If the user has not set the alarming device 180 to operate (“No” path from decision step S230), the surveillance system merely repeats the input/output operations of the current image I(t). If the user has set the alarming device 180 to operate (“Yes” path from decision step S230), the user sets a reference background image R(t) with respect to the object zone to be monitored through the user's setting section 170 (decision step S240).

If the user has set a predetermined reference background image R(t) for an object zone (“Yes” path from decision step S240) then the predetermined reference background image R(t) for an object zone is stored in the reference background image storage section 130 (step S251). If the user has not set a predetermined reference background image R(t) for an object zone (“No” path from decision step S240) then the surveillance system merely repeats the input/output operations of the current image I(t). Following step S251, the mean image storage section 123 outputs the previous mean image A(t−1) to the background area separation unit 122, and the image signal processing section 124 calculates the current mean image A(t) based on the previous mean image A(t−1) and the current input image I(t) (step S252). The background area separation section 122 extracts the background area B(t) by comparing the pixel values I(i, j, t) of the current input image with the pixel values A(i, j, t−1) of the previous mean image (step S253). The comparison section 140 calculates an absolute value of difference between the background area B(t) received from the background area separation section 122 and the reference background image R(t) received from the reference background image storage section 130 (step S254). The judging section 150 then determines whether the background area has been changed or not based on the result of calculation of S254, and outputs the result of the determination (decision step S255). If it is determined that the background area has been changed (“Yes” path from decision step S255), the alarming device 180 is operated to notify the situation to the user (step 260). If it is determined that the background area has not been changed (“No” path from decision step S255) then the surveillance system merely repeats the input/output operations of the current image I(t).

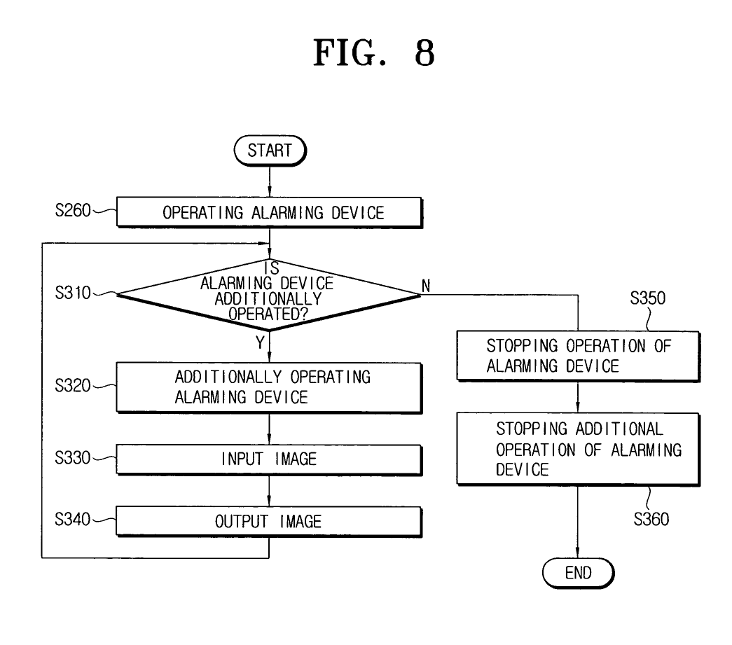

FIG. 8 is a flow chart illustrating a method for operating additional features of the alarming device 180 by the user's setting, when the alarming device 180 was previously operated. The background area of the input image is determined as having been changed if it is very different from the reference background image due to two reasons: First is the scenario in which an invader has actually invaded a watched zone and interrupted the normal operation of the image pick-up devices 110-1˜110-n, for example, by obscuring the lenses of the image pick-up devices 110-1˜110-n; and the second is the case in which foreign matter or objects in the air, such as dust, or the like sticks to the lens(es) of the camera(s), or winged insects such as a fly, mosquito, or the like sits on the lens(es), without any interrupting action by an invader. The surveillance system cannot distinguish the above two cases. Accordingly, if the latter case is considered as invasion of an invader and a security system is operated, it can give customers, who use a facility (such as a cash dispenser or a vending machine) within the object zone, an unpleasant feeling. Therefore, the inventive surveillance system operates the alarming device 180 to notify the users of the situation only when a change in the background area is detected (step S260 of FIG. 7). If the alarming device 180 is operated, the user determines whether an invader really invaded the object zone and interrupted the operation of the image pick-up devices 110-1˜110-n through the image output devices 160-1˜160-n, and if it is determined that there was an interrupting action of an invader, the user sets, through the user's setting device 170, the additional operation of the alarming device 180 (decision step S310). If the user sets the additional operation of the alarming device 180 (“Yes” path from decision step S310), the alarming device additionally operates, so that a siren installed within the object zone is operated, the entrance is closed, and/or a security agency is notified of the situation (step S320). Following step S320, image pick-up through the image pick-up devices 110-1˜110-n (step S330) and reproduction of the input image through the image output devices 160-1˜160-n (step S340) are repeated, and the user is continuously allowed to review the current situation of the object zone through the image output devices 160-1˜160-n. If the emergency situation is terminated or determined as being caused by an error in operation and not by the interrupting action of an invader, then it is possible to cancel the additional operation of the alarming device through the user's setting section 170 (“No” path from decision step S310), in which case the alarming device 180 will stop the alarming operation (step S350) and the additional operation (step S360). Even though it was determined that the background area was changed and thus the alarming device 180 has been operated, the user will not set the additional operation of the alarming device 180 if the operation is determined as having been caused by an error in operation and not by the interrupting action of an invader. As such, the alarming device 180 will stop the operation.

As described above, in accordance with the embodiments of the present invention, the change in background detection apparatus and method for detecting change in an background area, a situation can be detected in which a background area obtained by excluding a moving area from a current input image has been changed from a reference background image. Therefore, it is possible to enhance the efficiency of security, and to effectively cope with theft, physical calamity (fires, floods, among other types), or the like. Furthermore, it is possible to determine if an invader interrupts the normal operation of an image pick-up means by intentionally changing the angle of view of the camera lens, spraying a liquid on a camera lens, obscuring a lens with a garments or a piece of cloth, or cutting a camera cable.

While the preferred embodiments of the present invention has been shown and described with reference to the preferred embodiments thereof, the present invention is not limited to the embodiments. It will be understood that various modifications and changes can be made by those skilled in the art without departing from the spirit and scope of the invention as defined by the appended claims. It shall be considered that such modifications, changes and equivalents thereof are all included within the scope of the present invention.

It is claimed that:

1. A method for detecting change in a background area of an object zone in a video image, comprising:
setting and storing a reference background image R(t) with respect to the object zone to be monitored;
capturing periodically a current input image I(t) of the object zone by at least one image pick-up device;
extracting a background area B(t) of the object zone by excluding a moving area M(t) corresponding to one or more moving objects from the current input image I(t) of the object zone transmitted from the image pick-up devices;
comparing the background area B(t) with the reference background image R(t); and
judging whether the background area B(t) has changed relative to the reference background image R(t) on the basis of a comparison result comparing the background area B(t) and the reference background image R(t).

2. The method for detecting change in a background area of an object zone in a video image according to claim 1, wherein the step of extracting a background area B(t) of the object zone comprises:
calculating a previous mean image A(t−1);
comparing pixel values I(i, j, t) of the current input image with pixel values A(i, j, t−1) of the previous mean image A(t−1).

3. The method for detecting change in a background area of an object zone in a video image according to claim 2, wherein the step of calculating a previous mean image A(t−1) comprises:
calculating a current mean image A(t) based on the previous mean image A(t−1) and the current input image I(t); and
storing the current mean image A(t).

4. The method for detecting change in a background area of an object zone in a video image according to claim 3, wherein the step of calculating a current mean image A (I, j, t) based on the previous mean image A (I, j, t−1) and the current input image I (I, j, t) comprises:
determining the current mean image A (t) by the expression A(i, j, t)=(1−w)I(i, j, t)+wA(i, j, t−1), wherein;
w is a predetermined historical weight.

5. The method for detecting change in a background area of an object zone in a video image according to claim 4, wherein w is in the range from 0 to 1.

6. The method for detecting change in a background area of an object zone in a video image according to claim 2, wherein the step of comparing pixel values I (i, j, t) of the current input image with pixel values A (i, j, t−1) of the previous mean image A (t−1) comprises:
calculating an absolute value of a difference between the pixel value I (i, j, t) of the current input image and the pixel value A (i, j, t−1) of the previous mean image.

7. The method for detecting change in a background area of an object zone in a video image according to claim 6 further comprising:
determining that a change in the background area B (t) has occurred if the absolute value of the difference between the background area B (t) and the reference background image R (t) is greater than a first preset threshold value, T1, and therefore the change in the background area B (t) is denoted as a moving area M (t); and
determining that no change in the background area B (t) has occurred if the absolute value of the difference between the background area B (t) and the reference background image R (t) is less than or equal to the first preset threshold value, T1.

8. The method for detecting change in a background area of an object zone in a video image according to claim 1, wherein the step of comparing the background area B (t) with the reference background image R (t) comprises:
calculating at least one absolute value C (i, j, t) of a difference between a pixel value R (i, j, t) of the reference background image and a pixel value B (i, j, t) of the background area.

9. The method for detecting change in a background area of an object zone in a video image according to claim 1, wherein the step of judging whether the background area B (t) has changed relative to the reference background image R (t) on the basis of the comparison result comparing the background area B (t) and the reference background image R (t) comprises:
calculating a first number of pixel values in which C (i, j, t) is less than a second threshold T2; and
determining that the background area B (t) has changed with respect to the reference background image R (t) if the first number of pixel values is less than a third threshold value T3.

10. The method for detecting change in a background area of an object zone in a video image according to claim 9, wherein T2 is a value for determining whether pixel values of a background area B (i, j, t) have been changed or not, on the basis of the magnitudes of absolute values of difference between the pixel values of a background area and a reference image.

11. The method for detecting change in a background area of an object zone in a video image according to claim 9, wherein T3 is a value for determining whether the background area B (t) has been changed from the background reference image R (t) on the basis of the number of the changed pixels.

12. The method for detecting change in a background area of an object zone in a video image according to claim 1, wherein the step of judging further comprises:
transmitting the comparison result to an alarming device.

13. The method for detecting change in a background area of an object zone in a video image according to claim 1, further comprising:
setting up an alarming device with operating parameters to inform a user of a situation or not if an invader interrupts the normal operation of the at least one image pick-up device.

14. The method for detecting change in a background area of an object zone in a video image according to claim 1, further comprising:
operating the alarming device according to the operating parameters to notify the user of a change in the background area B(t) of the object zone.

15. The method for detecting change in a background area of an object zone in a video image according to claim 14, wherein the step of operating the alarming device according to the operating parameters to notify the user of a change in the background area B (t) of the object zone comprises:
operating a siren, closing an entrance or notifying a security agency of an alarm condition.

16. The method for detecting change in a background area of an object zone in a video image according to claim 1, further comprising:
viewing periodically a current output image I (t) of the object zone by at least one image output device.

17. A method for operating an alarming device when a change in a background area of an object zone is detected by an apparatus for detecting change in a background area of a video image, comprising:
operating the alarming device according to the operating parameters to notify the user of a change in the background area B (t) of the object zone;
determining whether a user has defined additional parameters for operating the alarming device when a change in the background area of an object zone has been detected and verified by the user, and if so, operating the alarming device in accordance with the additionally defined parameters; and
capturing a current input image I(t) of an object zone by at least one image pick-up device and viewing a current output image I(t) of the object zone by at least one image output device as long as the alarming device is operated.

18. The method for operating an alarming device when a change in a background area of an object zone is detected by an apparatus for detecting change in a background area of a video image according to claim 17, further comprising:
determining that a user has not defined additional parameters for operating the alarming device when a change in the background area of an object zone has been detected and verified by the user, and ceasing operation of the alarming device and ceasing additional operation of the alarming device.

19. An apparatus for detecting change in a background area of an object zone in a video image, comprising:
at least one or more input image pick-up devices for capturing periodically a current input image I (t) of the object zone;
a background extraction section for extracting a background area B(t) of the object zone in the video image;
a reference background image storage section for storing a reference background image R(t) of the object zone;
a comparison section for comparing the background area B(t) of the object zone output from the background area extraction section versus the reference background image R(t) of the object zone; and
a judging section for judging whether the background area B(t) has changed relative to the reference background image R(t) on the basis of a comparison result output from the comparison section.

20. The apparatus for detecting change in a background area of an object zone in a video image according to claim 19, wherein the background extraction section comprises:
a mean image calculation section for calculating a previous mean image A (t−1) up to a latest input image I (t−1) prior to a current input image I (t); and
a background area separation section for receiving the previous mean image A (t−1) from the mean image calculation section, receiving the current input image I (t), comparing a pixel value I (i, j, t) of the current input image I (t) with a pixel value A(i, j, t−1) of the previous mean image A (t−1), extracting an area determined as a background area B (t) of the object zone, and transmitting the background area B(t) to the comparison section.

21. The apparatus for detecting change in a background area of an object zone in a video image according to claim 20, wherein the mean image calculation section comprises:
an image signal processing section for receiving the current input image I (t) and calculating a current mean image A (t) based on the current input image I (t) and the previous mean image A (t−1); and
a mean image storage section for receiving the current mean image A (t) from the image signal processing section and transmitting the stored previous mean image A (t−1) to the image signal processing section and the background area separation section.

22. The apparatus for detecting change in a background area of an object zone in a video image according to claim 21, wherein the image signal processing section calculates a current mean image A (t) based on the following expression:
A(i, j, t)=(1−w)I(i, j, t)+wA(i, j, t−1), wherein w is a predetermined historical weight.

23. The apparatus for detecting change in a background area of an object zone in a video image according to claim 22, wherein w is in the range from 0 to 1.

24. The apparatus for detecting change in a background area of an object zone in a video image according to claim 20, wherein:
the background area separation section detects a change in the background section by determining that a change in the background area B (t) has occurred if the absolute value of the difference between the background area B (t) and the reference background image R (t) is greater than or equal to a first preset threshold value T1, and therefore the change in the background area B (t) is denoted as a moving area M (t), and determines that no change in the background area B(t) has occurred if the absolute value of the difference between the background area B (t) and the reference background image R (t) is less than the first preset threshold value T1.

25. The apparatus for detecting change in a background area of an object zone in a video image according to claim 19, wherein:
the background extraction section extracts a background area B (t) by calculating the absolute value of difference between the pixel value I (i, j, t) of the current input image and the pixel value A (i, j, t−1) of the previous mean image.

26. The apparatus for detecting change in a background area of an object zone in a video image according to claim 19, wherein:
the comparison section calculates an absolute value of a difference between the background area B (t) and the reference background image R (t), and transmits the calculated value to the judging section.

27. The apparatus for detecting change in a background area of an object zone in a video image according to claim 19, wherein:
the judging section calculates a first number of pixel values in which C (i, j, t) is less than a second threshold T2, and determines that the background area B (t) has changed with respect to the reference background image R (t) if the first number of pixel values is less than a third threshold value T3.

28. The apparatus for detecting change in a background area of an object zone in a video image according to claim 27, wherein T2 is a value for determining whether pixel values of a background area B (i, j, t) have been changed or not, on the basis of the magnitudes of absolute values of difference between the pixel values of a background area and a reference image.

29. The apparatus for detecting change in a background area of an object zone in a video image according to claim 27 wherein T3 is a value for determining whether the background area B (t) has been changed from the background reference image R (t) on the basis of the number of the changed pixels.

30. The apparatus for detecting change in a background area of an object zone in a video image according to claim 19, further comprising:
an alarming device; and
a user's setting section for setting at least one operational parameter for the operation of an alarming device, wherein the alarming device will provide an alarm based on the output of the judging section.

31. The apparatus for detecting change in a background area of an object zone in a video image according to claim 30, wherein:
the alarming device operates according to the operating parameters to notify the user of a change in the background area B (t) of the object zone.

32. The apparatus for detecting change in a background area of an object zone in a video image according to claim 30, wherein:
the alarming device operates according to the operating parameters to notify the user of a change in the background area B (t) of the object zone by operating a siren, closing an entrance or notifying a security agency of an alarm condition.

33. The apparatus for detecting change in a background area of an object zone in a video image according to claim 19, further comprising:
at least one image output device for providing a current output image I (t) of the object zone periodically.
